(19) United States
(12) Patent Application Publication
(10) Pub. No.: US 2018/0005152 A1
(43) Pub. Date: Jan. 4, 2018

(54) TECHNOLOGIES FOR CORRELATION BASED DATA SELECTION

(71) Applicant: Interactive Intelligence Group, Inc., Indianapolis, IN (US)

(72) Inventor: P. Randolph Carter, Durham, NC (US)

(21) Appl. No.: 15/638,174

(22) Filed: Jun. 29, 2017

Related U.S. Application Data
(60) Provisional application No. 62/356,409, filed on Jun. 29, 2016.

(51) Int. Cl. G06Q 10/06; G06K 9/62; G06F 17/18

(52) U.S. Cl. CPC G06Q 10/0637; G06K 9/623; G06F 17/18

(57) ABSTRACT

Technologies for correlation based data selection in a support call management system include a data analysis computing device of the support call management system that is configured to performing an analysis on support call data collected by a support call management computing device of the support call management system, apply a Pearson correlation coefficient filter to one or more results of the analysis, and display a result of the applied Pearson correlation coefficient filter. Additional embodiments are described herein.

### CROSS REFERENCE TO RELATED APPLICATIONS

The present application is related to, and claims the priority benefit of, U.S. Provisional Patent Application Ser. No. 62/356,409 filed Jun. 29, 2016, the contents of which are hereby incorporated in their entirety into the present disclosure.

### BACKGROUND OF THE DISCLOSED EMBODIMENTS

Statistical analysis tools are often used to perform correlation analysis on various sets of data. Such statistical analysis tools can be used to study the strength of a relationship between two variables (i.e., data points). For example, two data points having a strong, or high, correlation indicates that the two data points have a strong relationship; whereas two data points having a weak relationship is indicates by a weak, or low, correlation. The statistical analysis tools generally apply a filter to the data which produces a correlation coefficient, which can be used to interpret the strength of the relationship between the two data points being analyzed. One such correlation coefficient is the Pearson correlation coefficient (r), which assumes that the two data points being analyzed are measured on at least interval scales (i.e., measured on a range of increasing value). The Pearson correlation coefficient does so by measuring the correlation and covariance in data sets to determine whether the two data points tend to move together (i.e., correlation) or move apart (i.e., covariance) when one or the other data point changes.

Unfortunately, Pearson correlation coefficient has generally been an expensive calculation in large data sets since it has to be applied to a time series between each possible pair in a collection. Accordingly, in present enterprise business intelligence software, for example, Pearson correlation coefficient is a separate functional area used only on small data sets. While taking such an approach on data analysis with Pearson correlation coefficient conserves resources, it forces the business user to either have strong theories about correlations before even attempting to use the tools or using a trial an error where important insights may be missed. Accordingly, there exists a need for improvements in technologies for correlation based data selection.

### SUMMARY OF THE DISCLOSED EMBODIMENTS

In one aspect, a method for correlation based data selection in a support call management system includes performing, by a data analysis computing device of the support call management system, an analysis on support call data collected by a support call management computing device of the support call management system; applying, by the data analysis computing device, a Pearson correlation coefficient filter to one or more results of the analysis; and displaying, by the data analysis computing device, a result of the applied Pearson correlation coefficient filter.

In some embodiments, performing the analysis on the support call data comprises performing the analysis on one or more business processes associated with the support call data. In other embodiments, applying the Pearson correlation coefficient filter to one or more results of the analysis comprises applying the Pearson correlation coefficient filter to a subset of the support call data which is frequently used related behavioral data. In still other embodiments, displaying the result of the applied Pearson correlation coefficient filter comprises displaying one of a correlation or divergence of the support call data being analyzed. In still yet other embodiments, displaying the result of the applied Pearson correlation coefficient filter comprises displaying a trend over a period of time of the support call data being analyzed.

In some embodiments the method includes generating, by the data analysis computing device, a common performance report as a function of the results of the analysis. In other embodiments the method includes displaying, by the data analysis computing device, one or more correlation report generation parameters to a user; receiving, from the user, by the data analysis computing device, an indication of one or more selected correlation report generation parameters; performing, by the data analysis computing device, a correlation analysis on at least a portion of the support call data as a function of the one or more selected correlation report generation parameters; and displaying, by the data analysis computing device, a result of the correlation analysis to the user.

In some embodiments the method includes displaying, by the data analysis computing device, one or more result adjustment options to the user; receiving, from the user, by the data analysis computing device, an indication of one or more of the result adjustment options having been selected; performing, by the data analysis computing device, another correlation analysis on the at least a portion of the support call data as a function of the one or more selected result adjustment options; and displaying, by the data analysis computing device, a result of the other correlation analysis to the user.

In some embodiments, displaying the one or more result adjustment options to the user comprises displaying one or more additional data field options. In other embodiments, displaying the one or more result adjustment options to the user comprises displaying one or more alternative data filters.

In another aspect, a data analysis computing device for correlation based data selection in a support call management system includes one or more computer-readable medium comprising instructions; and one or more processors coupled with the one or more computer-readable medium and configured to execute the instructions to perform an analysis on support call data collected by a support call management computing device of the support call management system; apply a Pearson correlation coefficient filter to one or more results of the analysis; and display a result of the applied Pearson correlation coefficient filter.

In some embodiments, to perform the analysis on the support call data comprises to perform the analysis on one or more business processes associated with the support call data. In other embodiments, to apply the Pearson correlation coefficient filter to one or more results of the analysis comprises to apply the Pearson correlation coefficient filter to a subset of the support call data which is frequently used related behavioral data. In still other embodiments, to display the result of the applied Pearson correlation coefficient filter comprises to display one of a correlation or divergence of the support call data being analyzed. In yet still other embodiments, to display the result of the applied Pearson correlation coefficient filter comprises to display a trend over a period of time of the support call data being analyzed.

In some embodiments, the one or more processors are further configured to execute the instructions to generate a common performance report as a function of the results of the analysis. In other embodiments, the one or more processors are further configured to execute the instructions to display one or more correlation report generation parameters to a user; receive, from the user, by the data analysis computing device, an indication of one or more selected correlation report generation parameters; perform a correlation analysis on at least a portion of the support call data as a function of the one or more selected correlation report generation parameters; and display a result of the correlation analysis to the user.

In some embodiments, the one or more processors are further configured to execute the instructions to display one or more result adjustment options to the user; receive, from the user, by the data analysis computing device, an indication of one or more of the result adjustment options having been selected; perform another correlation analysis on the at least a portion of the support call data as a function of the one or more selected result adjustment options; and display a result of the other correlation analysis to the user.

In some embodiments, to display the one or more result adjustment options to the user comprises to display one or more additional data field options. In other embodiments, to display the one or more result adjustment options to the user comprises to display one or more alternative data filters.

### BRIEF DESCRIPTION OF DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a simplified block diagram of an illustrative embodiment for correlation based data selection which is illustratively shown in a support call management system that includes a support call management computing device and a data analysis computing device;

FIG. 2 is a simplified block diagram of an illustrative embodiment of at least one of the computing devices of the system of FIG. 1;

FIG. 3 is a simplified block diagram of an illustrative embodiment of an environment of a support call management platform of the support call management computing device of FIG. 1;

FIG. 4 is a simplified block diagram of an illustrative embodiment of an environment of a correlation analysis platform of the data analysis computing device of FIG. 1;

FIG. 5 is a simplified flow diagram of an illustrative embodiment of a method for collecting support call data that may be executed by the support call management platform of FIGS. 1 and 3;

FIG. 6 is a simplified flow diagram of an illustrative embodiment of a method for analyzing support call data that may be executed by the correlation analysis platform of FIGS. 1 and 4; and

FIG. 7 is a simplified flow diagram of an illustrative embodiment of a method for displaying results of a correlation based data analysis operation that may be executed by the correlation analysis platform of FIGS. 1 and 4.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

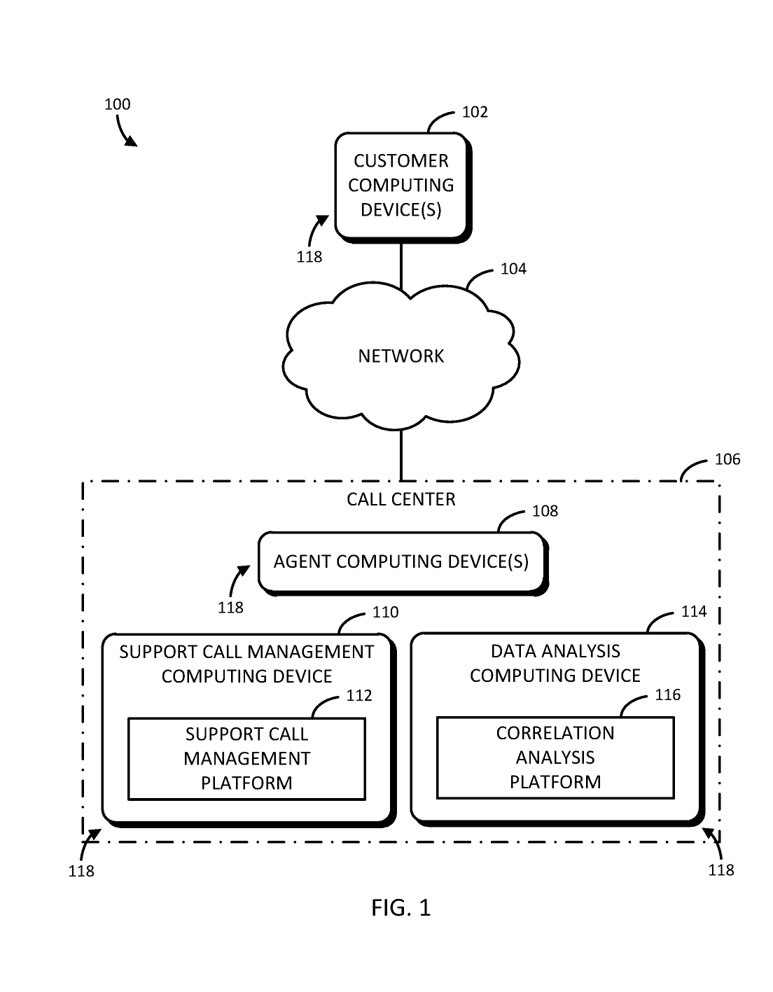

FIG. 1 is an illustrative support call management system 100 which is illustratively shown for performing the correlation based data selection operations described herein. The illustrative support call management system 100 includes one or more customer computing devices 102 communicatively coupled to a call center 106 via a network 104. The illustrative call center 106 includes one or more agent computing devices 108, a support call management computing device 110, and a data analysis computing device 114.

In an illustrative example, a customer interested in speaking to an agent (e.g., a customer service agent) of a good and/or service provider contacts the provider's service/support line (e.g., via a respective one of the customer computing devices 102) which is managed by the call center, or more particularly by the support call management computing device 110. Upon receiving the call, the support call management computing device 110, which is configured to receive inbound support call traffic and route the support call traffic to customer service agents (e.g., via their respective agent computing devices 108), determines which agent to route the call to. Throughout the duration of the call, the support call management computing device 110 is additionally configured to collect information (e.g., about the user, about the call, about the agent(s), etc.) for analysis.

In use, as described in further detail below, the data analysis computing device 114 is configured to run performance reports on the collected support call data. To do so, the data analysis computing device 114 is configured to perform a Pearson correlation coefficient analysis using a standardized time interval. Accordingly, the data analysis computing device 114 can use the results of the Pearson correlation coefficient analysis as a facet by which to determine and display relationships between data points, such as data points that move in the same, data points that move in the opposite directions, data points that move in a direction which are unexpected, etc. As such, users can understand which processes (e.g., business processes) are related, which may re-enforce deeper relationships in the data. In other words, the data analysis computing device 114 is configured to push the Pearson correlation coefficient analysis results into the report generation process, enabling users to explore and use the findings in the beginning of their analysis, unlike present technologies in which the Pearson correlation coefficient analysis is constructed as a hypothesis and used to test in a narrow dedicated function (i.e., the Pearson correlation coefficient analysis performed as an end result).

Additionally, the data analysis computing device 114 is configured to perform the Pearson correlation coefficient analysis over time to discover trends, such as data that has converged over the course of the year, data that is becoming less related over the last several months, etc. Doing so can support critical insights into changes in business which may not otherwise be visible to management. Further, performing the Pearson correlation coefficient analysis over time can identify which processes are changing together (e.g., are well-synchronized) and which processes are diverging (e.g., where problems may be developing). Accordingly, unlike present technologies, the data analysis computing device 114 is configured to, as a function of the trend analysis, identify to a user when a date range for a comparison they are studying has atypical data as compared to wider date ranges of analysis of that same data.

As described previously, the call center 106 illustratively includes the agent computing device(s) 108, the support call management computing device 110, and the data analysis computing device 114. It should be appreciated that the call center 106 may be comprised of any number of compute/storage servers, as well as other network devices (e.g., switches, hubs, routers, access points, etc.), which may be housed in a data center, for example. It should be further appreciated that, in some embodiments, one or more of the illustrative computing devices 118, such as the data analysis computing device 114, may not be located proximate to the call center 106 (e.g., a remote cloud infrastructure).

It should be appreciated that each of the support call management computing device 110 and the data analysis computing device 114, while illustratively shown as a single computing device 118, may be comprised of more than one computing device 118, in other embodiments. The customer computing device(s) 102, the agent computing device(s) 108, the support call management computing device 110, and the data analysis computing device 114 may each be embodied as any type of computing device 118 capable of performing the respective functions described herein. For example, in some embodiments, one or more of the customer computing devices 102 and the agent computing devices 108 may be embodied as desktop computers or mobile computing devices (e.g., smartphones, wearables, tablets, laptops, notebooks, etc.). In furtherance of the example, in some embodiments, the support call management computing device 110 and/or the data analysis computing device 114 may be embodied as one or more servers (e.g., stand-alone, rack-mounted, etc.), compute devices, storage devices, and/or combination of compute blades and data storage devices (e.g., of a storage area network (SAN)) in a cloud architected network or data center.

It should be appreciated that, in some embodiments, the customer computing devices 102, the remote agent computing device 110, the call center management computing device 118, and/or the local agent computing devices 126 may include more than one computing device 118 (e.g., in a distributed computing architecture), each of which may be usable to perform at least a portion of the functions described herein of the respective computing device 118. In other words, in some embodiments, one or more functions of the call center management computing device 118 may be executed on one or more computing devices 118, while one or more same, additional, or alternative functions of the call center management computing device 118 may be executed on one or more other computing devices 118.

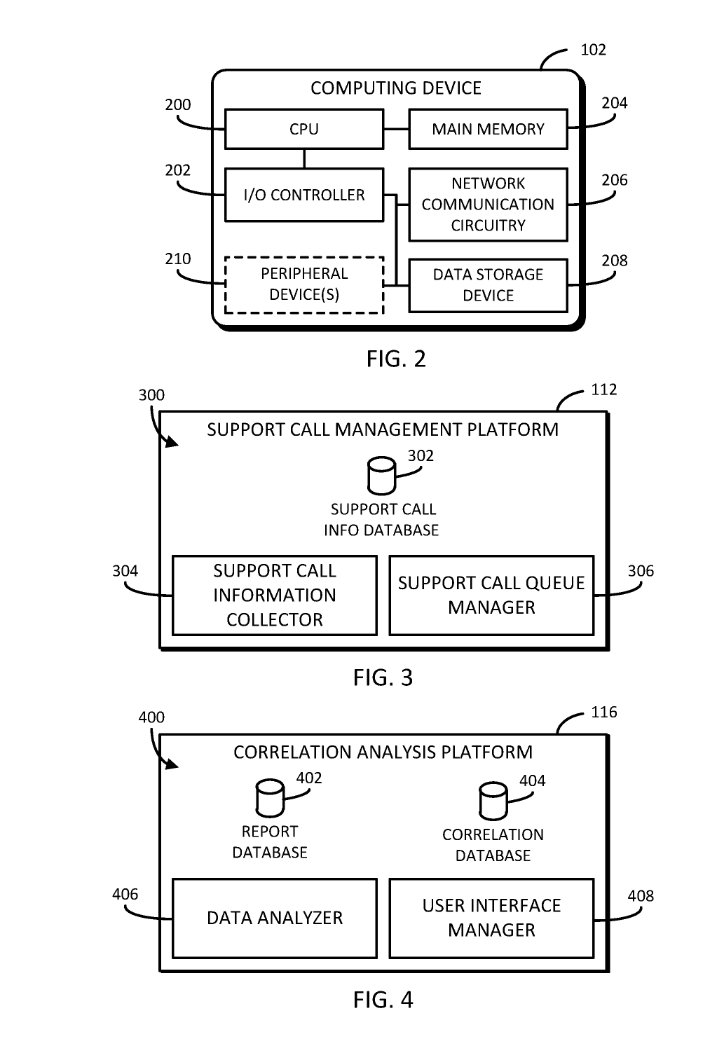

Referring now to FIG. 2, an illustrative computing device 118 (e.g., one of the customer computing devices 102, one of the agent computing devices 108, the support call management computing device 110, and/or the data analysis computing device 114) includes a central processing unit (CPU) 200, an input/output (I/O) controller 202, a main memory 204, network communication circuitry 206, a data storage device 208, and one or more I/O peripherals 210. In some alternative embodiments, the computing device 118 may include additional, fewer, and/or alternative components to those of the illustrative computing device 118, such as a graphics processing unit (GPU). It should be appreciated that one or more of the illustrative components may be combined on a single system-on-a-chip (SoC) on a single integrated circuit (IC).

Additionally, it should be appreciated that the type of components and/or hardware/software resources of the respective computing device 118 may be predicated upon the type and intended use of the respective computing device 118. For example, the call center management computing device 118 may not include any peripheral devices 210. Additionally, as described previously, the call center management computing device 118 may be comprised of more than one computing device 118. Accordingly, in such embodiments, it should be further appreciated that one or more computing devices 118 of the call center management computing device 118 may be configured as a database server with less compute capacity and more storage capacity relative to another of the computing devices 118 of the call center management computing device 118. Similarly, one or more other computing devices 118 of the call center management computing device 118 may be configured as an application server with more compute capacity relative and less storage capacity relative to another of the computing devices 118 of the call center management computing device 118.

The CPU 200, or processor, may be embodied as any combination of hardware and circuitry capable of processing data. In some embodiments, the computing device 118 may include more than one CPU 200. Depending on the embodiment, the CPU 200 may include one processing core (not shown), such as in a single-core processor architecture, or multiple processing cores, such as in a multi-core processor architecture. Irrespective of the number of processing cores and CPUs 200, the CPU 200 is capable of reading and executing program instructions. In some embodiments, the CPU 200 may include cache memory (not shown) that may be integrated directly with the CPU 200 or placed on a separate chip with a separate interconnect to the CPU 200. It should be appreciated that, in some embodiments, pipeline logic may be used to perform software and/or hardware operations (e.g., network traffic processing operations), rather than commands issued to/from the CPU 200.

The I/O controller 202, or I/O interface, may be embodied as any type of computer hardware or combination of circuitry capable of interfacing between input/output devices and the computing device 118. Illustratively, the I/O controller 202 is configured to receive input/output requests from the CPU 200, and send control signals to the respective input/output devices, thereby managing the data flow to/from the computing device 118.

The memory 204 may be embodied as any type of computer hardware or combination of circuitry capable of holding data and instructions for processing. Such memory 204 may be referred to as main or primary memory. It should be appreciated that, in some embodiments, one or more components of the computing device 118 may have direct access to memory, such that certain data may be stored via direct memory access (DMA) independently of the CPU 200.

The network communication circuitry 206 may be embodied as any type of computer hardware or combination of circuitry capable of managing network interfacing communications (e.g., messages, datagrams, packets, etc.) via wireless and/or wired communication modes. Accordingly, in some embodiments, the network communication circuitry 206 may include a network interface controller (NIC) capable of being configured to connect the computing device 118 to a computer network, as well as other devices, depending on the embodiment.

The data storage device 208 may be embodied as any type of computer hardware capable of the non-volatile storage of data (e.g., semiconductor storage media, magnetic storage media, optical storage media, etc.). Such data storage devices 208 are commonly referred to as auxiliary or secondary storage, and are typically used to store a large amount of data relative to the memory 204 described above.

The I/O peripherals 210 may be embodied as any type of auxiliary device configured to connect to and communicate with the computing device 118. Depending on the embodiment, the one or more I/O peripherals 210 may include a display, a microphone, a speaker, a mouse, a keyboard, a touchscreen, a camera, a printer, a scanner, etc. Accordingly, it should be appreciated that some I/O devices are capable of one function (i.e., input or output), or both functions (i.e., input and output).

In some embodiments, the I/O peripherals 210 may be connected to the computing device 118 via a cable (e.g., a ribbon cable, a wire, a universal serial bus (USB) cable, a high-definition multimedia interface (HDMI) cable, etc.) connected to a corresponding port (not shown) of the computing device 118 through which the communications made therebetween can be managed by the I/O controller 202. In alternative embodiments, the I/O peripherals 210 may be connected to the computing device 118 via a wireless mode of communication (e.g., Bluetooth®, Wi-Fi®, etc.) which may be managed by the network communication circuitry 206.

Referring back to FIG. 1, as noted previously, the customer computing devices 102 are communicatively coupled to the call center 106, or more particularly to the support call management computing device 110 of the call center, via the network 104. The network 104 may be implemented as any type of wired and/or wireless network, including a local area network (LAN), a wide area network (WAN), a global network (the Internet), etc. Accordingly, the network 104 may include one or more communicatively coupled network computing devices (not shown) for facilitating the flow and/or processing of network communication traffic via a series of wired and/or wireless interconnects. Such network computing devices may include, but are not limited, to one or more access points, routers, switches, servers, compute devices, storage devices, etc. It should be appreciated that the customer computing devices 102 and the support call management computing device 110 may use different networks (e.g., LANs, provider networks, etc.) to connect to the backbone of the network 104 such that a number of communication channels can be established therein to enable communications therebetween.

The illustrative support call management computing device 110 includes a support call management platform 112 which, as will be described in further detail below, is configured to receive inbound support call traffic and route the support call traffic to customer service agents (e.g., via their respective agent computing devices 108). As described previously, the illustrative data analysis computing device 114 includes the correlation analysis platform 116. Each of the support call management computing device 110 and the correlation analysis platform 116 may be embodied as any combination of hardware, firmware, software, or circuitry usable to perform the functions described herein.

The support call management computing device 110 and the correlation analysis platform 116 include or otherwise have access to one or more computer-readable medium (e.g., the memory 204, the data storage device 208, and/or any other media storage device) having instructions stored thereon and one or more processors (e.g., the CPU 200) coupled with the one or more computer-readable medium and configured to execute instructions to perform the functions described herein. While the functionality of the support call management computing device 110 and/or the correlation analysis platform 116 may be described herein as being performed by a particular component or set of components, it should be appreciated that, in other embodiments, the support call management computing device 110 and/or the correlation analysis platform 116 may include additional and/or alternative components for performing the functions described herein.

It should be further appreciated that, in some embodiments, the data stored in the respective databases as described herein with respect to the associated platform may not be mutually exclusive. In other words, certain data described herein as being stored in one database may additionally or alternatively be stored in another database described herein, or another database altogether. It should be further appreciated that, in some embodiments, the data may be stored in a single database, or an alternative database/data storage arrangement. Additionally, the illustrative databases described herein may be combined or further segregated, in other embodiments. In some embodiments, access to the data provided to and/or generated as described herein may require authorization and/or that such data is encrypted while in storage and/or transit. Accordingly, in such embodiments, one or more authentication and/or encryption technologies known to those of skill in the art may be employed to ensure the storage and access to the data complies with any legal and/or contractual requirements.

Referring now to FIG. 3, an illustrative environment 300 of the support call management platform 112 of the support call management computing device 110 is shown. The illustrative environment 300 includes a support call information database 302, a support call information manager collector 304, support call queue manager 306. The support call information collector 304 is configured to collect support call information and store the collected support call information (e.g., in the support call information database 302) for later retrieval. The collected support call information may include any kind of information related to the support call, such as, but not limited to, information associated with the caller (e.g., a caller identifier, geographic location, demographic information, etc.), information associated with the one or more agents responding to the call (e.g., agent identifier(s), notes, a resolution code, etc.), information associated with the call itself (e.g., a type of call, a hold time, a call duration, etc.), etc. Accordingly, the support call information collector 304 is configured to monitor certain metrics of the call throughout the duration of the call, as well as receive input (e.g., from the agent) which may be associated with the call.

The support call queue manager 306 is configured to receive inbound support call traffic and route the support calls to the appropriate customer service agents (e.g., via their respective agent computing devices 108). To do so, the support call queue manager 306 is configured to create/remove support call queues, identify an appropriate support call queue for each call, and forward the calls from the support call queues to the agents as necessary. The support call queue in which the call is placed may be determined based on the type of support being requested (e.g., customer service, billing, tech support, etc.), one or more characteristics of the caller (e.g., demographic data of the caller, geographic data of the caller, caller support history, etc.), one or more characteristics of the support call queue (e.g., a present volume of the support call queue, a capacity of the support call queue, a location of the agent(s) responsible for the support call queue, etc.), etc.

Referring now to FIG. 4, an illustrative environment 400 of the correlation analysis platform 116 of the data analysis computing device 114 is shown. The illustrative environment 400 includes a report database 402, a correlation database 404, a data analyzer 406, and a user interface manager 408.

The data analyzer 406 is configured to run analyses on support call data, such as may be collected by the support call management platform 112. For example, the data analyzer 406 is configured to perform common data analyses on at least a portion of the support call data such that performance reports can be generated therefrom. Additionally, the data analyzer 406 is configured to run a Pearson correlation coefficient analysis on at least a portion of the support call data such that the Pearson correlation coefficient can be used as a standard filter and facet to view data, can be used to customize reports, can illustrate trends, can identify and suggest interesting data, and the like. To do so, the data analyzer 406 is configured to continuously calculate the Pearson correlation coefficient for common data such that additionally analysis may be performed based thereon. In some embodiments, the data analyzer 406 is configured to run a Pearson correlation coefficient analysis on the related behavioral call support data using a standardized time interval. It should be appreciated that the data analyzer 406 may be configured to use one or more machine learning algorithms to perform at least a portion of the functions described herein, such as the early detection of key business processes based on long-term Pearson correlation coefficient series comparison.

The user interface manager 408 is configured to interface with a user of the correlation analysis platform 116. To do so, the user interface manager 408 is configured to generate, transmit, and receive network communications with code (e.g., hypertext markup language (HTML), JavaScript Object Notation (JSON), extensible markup language (XML), etc.) that is usable to render user interface elements to a display of the user, such as may be used to provide information to and/or request feedback from the user, and receive requested feedback from the user. For example, the user interface manager 408 may be configured to provide information usable to display text, icons, graphics, etc., which are usable to select data resulting from the correlation analysis, access tools for investigating processes using correlations and covariance as a filter, etc.

In some embodiments, the Pearson correlation coefficient analysis data can be made available through generated reports via an application programming interface (API), such as a representational state transfer (REST) API which can be used by web services and other applications. In such embodiments, the user interface manager 408 may be configured to function as a manager of such API calls. In other words, in some embodiments, the user interface manager 408 may be configured to manage the interface between an application/service and the correlation analysis platform 116, in addition or alternative to managing the interface between a user and the correlation analysis platform 116.

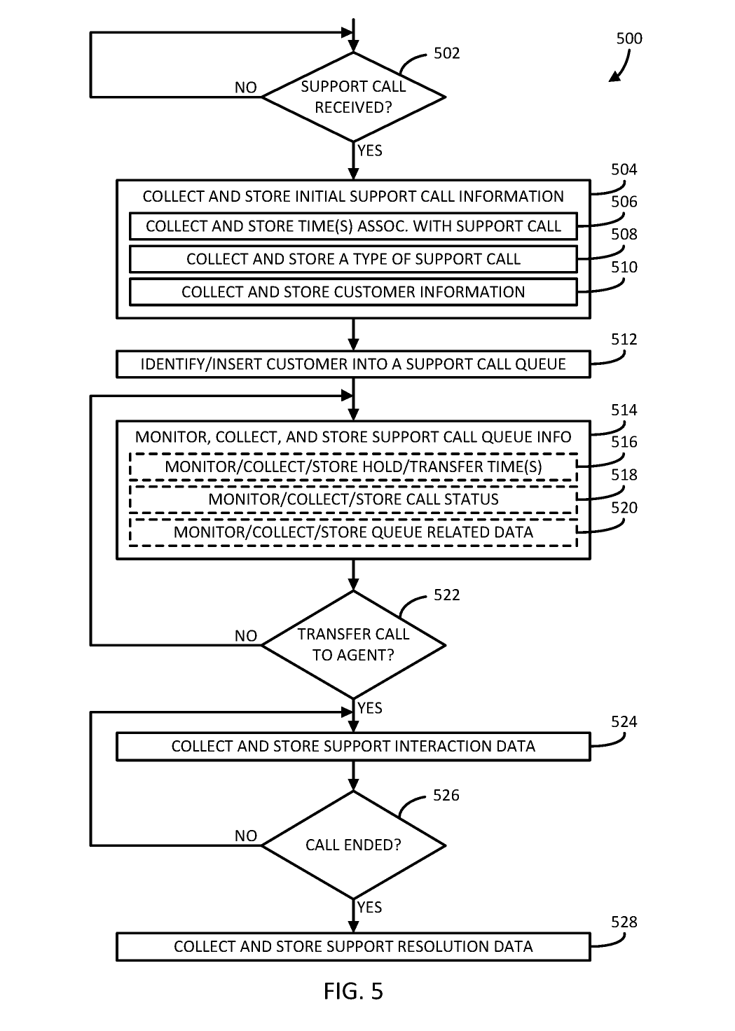

Referring now to FIG. 5, an illustrative method 500 is provided for collecting support call data which may be executed by the support call management computing device 110, or more particularly the support call management platform 112 of the support call management computing device 110. The method 500 begins in block 502, in which the support call management platform 112 determines whether a service/support call has been received. If a call has been received, the method 500 advances to block 504.

In block 504, the support call management platform 112 collects and stores initial support call information. To do so, in block 506, the support call management platform 112 collects and stores times associated with the support call, such as a time in which the call was received, a time at which the call was inserted into a queue, a time at which the call was dropped, etc. Additionally, in block 508, the support call management platform 112 collects and stores a type of support being requested, such as whether the call is a customer service call, a goods/services procurement call, a billing call, a tech support call, etc. Further, in block 510, the support call management platform 112 collects and stores customer information, such as an identifier of the customer, demographic information of the customer, geographic information of the customer, etc.

In block 512, the support call management platform 112 identifies/inserts the support call into a support call queue, such as may be based on the type of call, available agents, a history of the caller, etc. In block 514, the support call management platform 112 monitors, collects, and stores support call queue information. To do so, in block 516, the support call management platform 112 monitors, collects, and stores hold/transfer times associated with the call. Additionally, in block 518, the support call management platform 112 monitors, collects, and stores a call status, such as whether the call is connected, was disconnected, is muted, etc. Further, in block 520, the support call management platform 112 monitors, collects, and stores support call queue related information, such as a support call queue identifier, a position in the support call queue, a support call queue volume, an average support call hold time, etc.

In block 522, the support call management platform 112 determines whether to transfer the call to an agent. If so, the method 500 advances to block 524, in which the support call management platform 112 is configured to collect and store support interaction data. Such support interaction data may include any data associated with the support interaction, such as agent notes, steps taken to assist the caller, a duration of the call, etc. In block 526, the support call management platform 112 determines whether the call has ended, either by the agent, the caller, or the connection. If the call has not ended, the method 500 returns to block 524, in which the support call management platform 112 continues to collect and store support interaction data. Otherwise, if the call has ended, the support call management platform 112 collects and stores support resolution data. Such support resolution data may include a resolution code/identifier, a subsequent action to be taken, a duration of the call, a summary of the interaction, etc.

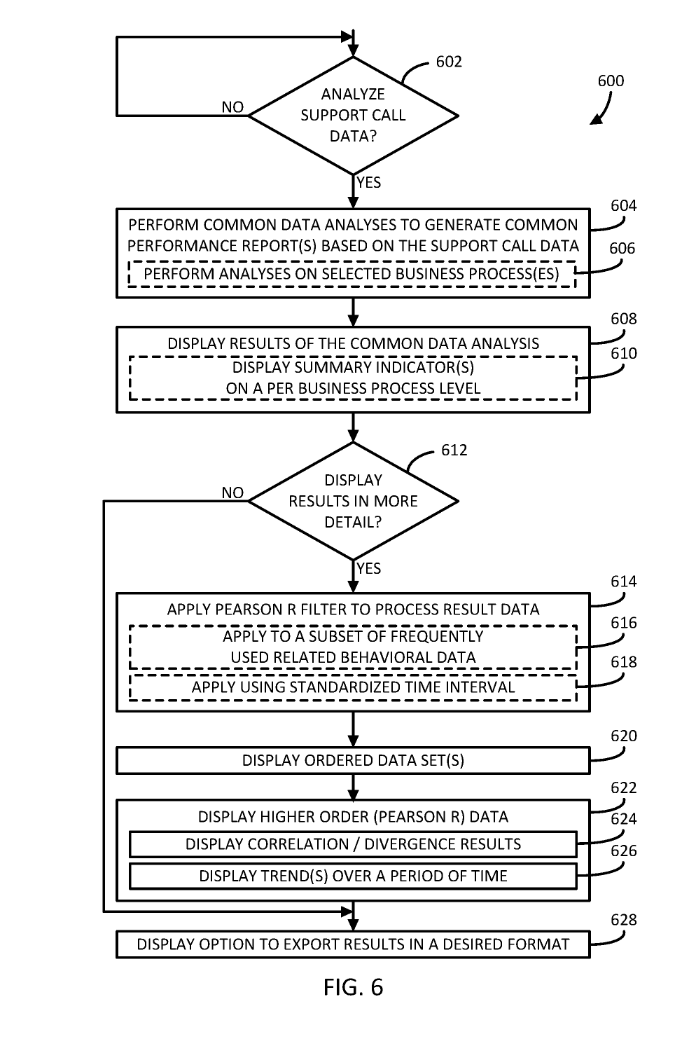

Referring now to FIG. 6, an illustrative method 600 is provided for analyzing support call data which may be executed by the data analysis computing device 114, or more particularly the correlation analysis platform 116 of the data analysis computing device 114. The method 600 begins in block 602, in which the correlation analysis platform 116 determines whether to analyze support call data. If so, the method 600 advances to block 604. It should be appreciated that the method 600 may be triggered by a user (e.g., to generate a report) or automatically without user intervention (e.g., upon a predetermined time interval, upon detecting a triggering action during analysis and/or data collection, etc.).

In block 604, the correlation analysis platform 116 performs a common data analyses to generate one or more common performance reports on the support call data to be analyzed, such as, but not limited to, a relationship of replacements shipped relative to issues reported, successful call resolutions reports relative to customer response rates, agent hours per week relative to customer net promoter score, etc. It should be appreciated that, in some embodiments, only a portion of the support call data may be analyzed at a given time. For example, in block 606, the correlation analysis platform 116 may perform the analyses on one or more business processes, such as may be selected by a user. In block 608, the correlation analysis platform 116 displays results of the common data analysis. To do so, in block 610, the correlation analysis platform 116 displays one or more summary indicators on a per business process level.

In block 612, the correlation analysis platform 116 determines whether to display the results in more detail, such as may be initiated by a user. If not, the method 600 branches to block 628, which is described below and shown in FIG. 6B; otherwise, the method advances to block 614, in which the correlation analysis platform 116 applies a Pearson correlation coefficient filter to the appropriate data set(s) to process the result data. To do so, in block 616, the correlation analysis platform 116 may be configured to apply the Pearson correlation coefficient filter to a subset of frequently used related behavioral data. Additionally or alternatively, in block 618, the correlation analysis platform 116 may apply the Pearson correlation coefficient filter using a standardized time interval.

In block 620, the correlation analysis platform 116 displays the one or more ordered data sets. In block 622, the correlation analysis platform 116 displays the higher order data set (i.e., the Pearson correlation coefficient analysis results). To do so, in block 624, the correlation analysis platform 116 displays correlation/divergence results. Additionally, in block 626, the correlation analysis platform 116 displays one or more trends over a period of time.

In an illustrative example, the correlation analysis platform 116 may be configured to display a first order data set which can be used to determine a level of activity, a second order data set which can be used to determine how that level of activity compares to a previous period of time and/or to a threshold, a third order data set which can be used to determine how the activity level has trended over a period of time, and a higher order data set (i.e., a result of the Pearson correlation coefficient analysis) which is usable to compare the activity to other processes to determine whether the activity is becoming more correlated (e.g., more synchronized) or is diverging (e.g., less synchronized).

In block 628, the correlation analysis platform 116 displays an option to export the results in a desired format (e.g., generate a visual report of the data). It should be appreciated that, in some embodiments, the displayed option may consist of a graphical object/element displayed to a user, which upon selection would allow them to choose to export at least a portion of the results and select an export format. It should be further appreciated that, in some embodiments, the user may be prompted to display particular results in even further detail or over a more narrow/broader range of time, in which a least a portion of the method 600 (e.g., blocks 612-622) may be repeated.

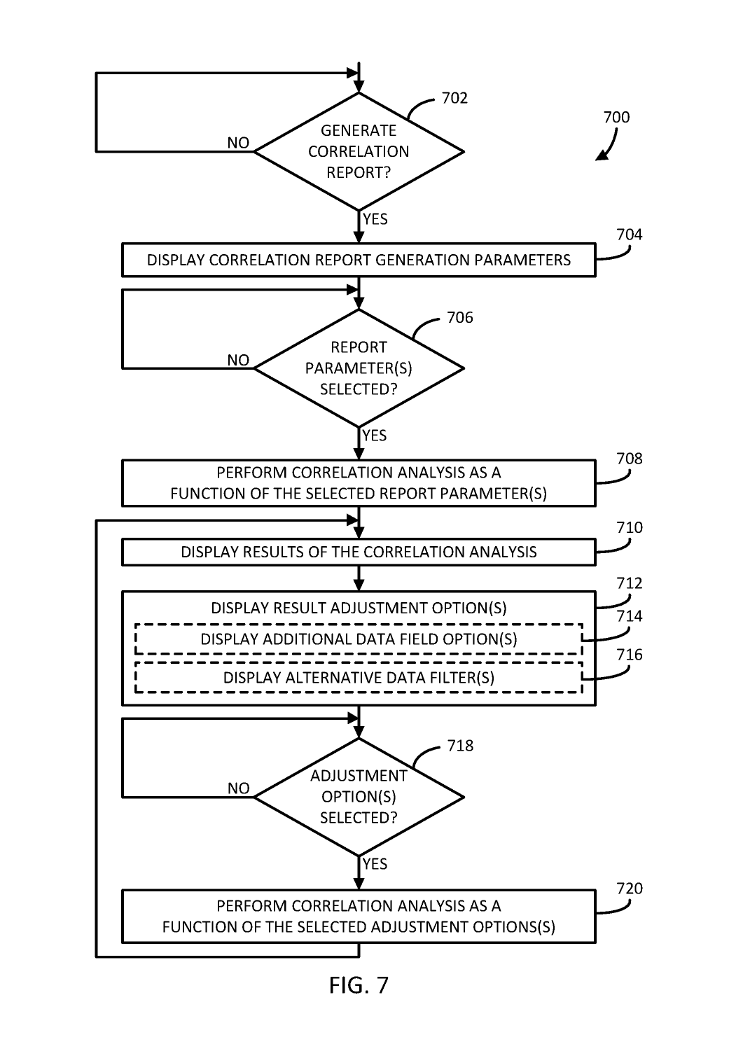

Referring now to FIG. 7, an illustrative method 700 is provided for displaying results of a correlation based data analysis operation which may be executed by the data analysis computing device 114, or more particularly the correlation analysis platform 116 of the data analysis computing device 114. The method 700 begins in block 702, in which the correlation analysis platform 116 determines whether to generate a correlation report (i.e., a report of a correlation analysis as described in the method 600 FIG. 6). If so, the method 700 advances to block 704. It should be appreciated that the method 700 may be triggered by a user (e.g., creating a new report, editing an existing report, etc.) or automatically without user intervention (e.g., at a particular time of day, on a particular day of the week/month, upon detecting a triggering action during analysis and/or data collection, etc.).

In block 704, the correlation analysis platform 116 displays a set of correlation report generation parameters to a user (e.g., an administrator, a data analyst, a manager, etc.). The set of correlation report generation parameters may include categories of data of an existing report or to include in a new report. It should be appreciated that to display information and/or receive input from the user as described herein, the correlation analysis platform 116 is configured to transmit code (e.g., HTML, JSON, XML, etc.) that is usable by the receiving computing device to render user interface elements to a display of the receiving computing device for viewing by the user. It should be further appreciated that such code may be transmitted to the receiving computing device directly by the data analysis computing device 114 or through the support call management computing device 110, depending on the embodiment. In block 706, the correlation analysis platform 116 determines whether one or more of the report generation parameters have been selected (e.g., by a user, by a command line call, by an API call, etc.). If so, the method 700 advances to block 708, in which the correlation analysis platform 116 performs a correlation analysis as a function of the one or more selected report parameters.

In block 710, the correlation analysis platform 116 displays the results of the correlation analysis (e.g., in a visual representation of the data in text and/or pictorial format). In block 712, the correlation analysis platform 116 displays one or more result adjustment options. For example, in block 714, the correlation analysis platform 116 may display one or more additional data field options. In another example, in block 716, the correlation analysis platform 116 may additionally or alternatively display one or more alternative data filters as a function of the Pearson correlation coefficient. The one or more alternative data filters includes correlated data (i.e., data that moves relatively the same), diverging data (i.e., data that move relative opposite), and other data (i.e., data that that has a relationship but the closeness of the relationship is not readily identifiable).

In block 718, the correlation analysis platform 116 determines whether one or more adjustment options have been selected. If so, the method 700 advances to block 720, in which the correlation analysis platform 116 performs the correlation analysis as a function of the selected adjustment option(s). The method 700 then returns to block 710 to display the results of the adjusted correlation analysis. It should be appreciated that, in some embodiments, the correlation analysis platform 116 may allow the user to export the results in the correlation report (e.g., as described in block 628 of the method 600 of FIG. 6) at any given time during execution of the method 700 as appropriate.

While the illustrative embodiment described herein as a support call management system 100, it should be appreciated that the functions of the correlation analysis platform 116 as described herein may be used in other embodiments, such as any type of enterprise business intelligence software. Additionally, while the present disclosure has been illustrated and described in detail in the drawings and foregoing description, the same is to be considered as illustrative and not restrictive in character, it being understood that only certain embodiments have been shown and described, and that all changes and modifications that come within the spirit of the present disclosure are desired to be protected.

What is claimed is:

1. A method for correlation based data selection in a support call management system, the method comprising:
performing, by a data analysis computing device of the support call management system, an analysis on support call data collected by a support call management computing device of the support call management system;
applying, by the data analysis computing device, a Pearson correlation coefficient filter to one or more results of the analysis; and
displaying, by the data analysis computing device, a result of the applied Pearson correlation coefficient filter.

2. The method of claim 1, wherein performing the analysis on the support call data comprises performing the analysis on one or more business processes associated with the support call data.

3. The method of claim 1, wherein applying the Pearson correlation coefficient filter to one or more results of the analysis comprises applying the Pearson correlation coefficient filter to a subset of the support call data which is frequently used related behavioral data.

4. The method of claim 1, wherein displaying the result of the applied Pearson correlation coefficient filter comprises displaying one of a correlation or divergence of the support call data being analyzed.

5. The method of claim 1, wherein displaying the result of the applied Pearson correlation coefficient filter comprises displaying a trend over a period of time of the support call data being analyzed.

6. The method of claim 1, further comprising generating, by the data analysis computing device, a common performance report as a function of the results of the analysis.

7. The method of claim 1, further comprising:
displaying, by the data analysis computing device, one or more correlation report generation parameters to a user;
receiving, from the user, by the data analysis computing device, an indication of one or more selected correlation report generation parameters;
performing, by the data analysis computing device, a correlation analysis on at least a portion of the support call data as a function of the one or more selected correlation report generation parameters; and
displaying, by the data analysis computing device, a result of the correlation analysis to the user.

8. The method of claim 7, further comprising:
displaying, by the data analysis computing device, one or more result adjustment options to the user;
receiving, from the user, by the data analysis computing device, an indication of one or more of the result adjustment options having been selected;
performing, by the data analysis computing device, another correlation analysis on the at least a portion of the support call data as a function of the one or more selected result adjustment options; and
displaying, by the data analysis computing device, a result of the other correlation analysis to the user.

9. The method of claim 8, wherein displaying the one or more result adjustment options to the user comprises displaying one or more additional data field options.

10. The method of claim 8, wherein displaying the one or more result adjustment options to the user comprises displaying one or more alternative data filters.

11. A data analysis computing device for correlation based data selection in a support call management system, the data analysis computing device comprising:
one or more computer-readable medium comprising instructions; and
one or more processors coupled with the one or more computer-readable medium and configured to execute the instructions to:
perform an analysis on support call data collected by a support call management computing device of the support call management system;
apply a Pearson correlation coefficient filter to one or more results of the analysis; and
display a result of the applied Pearson correlation coefficient filter.

12. The data analysis computing device of claim 11, wherein to perform the analysis on the support call data comprises to perform the analysis on one or more business processes associated with the support call data.

13. The data analysis computing device of claim 11, wherein to apply the Pearson correlation coefficient filter to one or more results of the analysis comprises to apply the Pearson correlation coefficient filter to a subset of the support call data which is frequently used related behavioral data.

14. The data analysis computing device of claim 11, wherein to display the result of the applied Pearson correlation coefficient filter comprises to display one of a correlation or divergence of the support call data being analyzed.

15. The data analysis computing device of claim 11, wherein to display the result of the applied Pearson correlation coefficient filter comprises to display a trend over a period of time of the support call data being analyzed.

16. The data analysis computing device of claim 11, wherein the one or more processors are further configured to execute the instructions to generate a common performance report as a function of the results of the analysis.

17. The data analysis computing device of claim 11, wherein the one or more processors are further configured to execute the instructions to:
display one or more correlation report generation parameters to a user;
receive, from the user, by the data analysis computing device, an indication of one or more selected correlation report generation parameters;
perform a correlation analysis on at least a portion of the support call data as a function of the one or more selected correlation report generation parameters; and
display a result of the correlation analysis to the user.

18. The data analysis computing device of claim 17, wherein the one or more processors are further configured to execute the instructions to:
display one or more result adjustment options to the user;
receive, from the user, by the data analysis computing device, an indication of one or more of the result adjustment options having been selected;
perform another correlation analysis on the at least a portion of the support call data as a function of the one or more selected result adjustment options; and
display a result of the other correlation analysis to the user.

19. The data analysis computing device of claim 18, wherein to display the one or more result adjustment options to the user comprises to display one or more additional data field options.

20. The data analysis computing device of claim 18, wherein to display the one or more result adjustment options to the user comprises to display one or more alternative data filters.
